(19) United States
(12) Patent Application Publication
(10) Pub. No.: US 2026/0104889 A1
(43) Pub. Date: Apr. 16, 2026

(54) REALISTIC SCALABILITY TESTING AND PERFORMANCE METRIC MEASUREMENT FOR APPLICATIONS

(71) Applicant: Notion Labs, Inc., San Francisco, CA (US)

(72) Inventor: Peter Lu, San Francisco, CA (US)

(21) Appl. No.: 19/077,973

(22) Filed: Mar. 12, 2025

Related U.S. Application Data
(60) Provisional application No. 63/708,185, filed on Oct. 16, 2024.

(51) Int. Cl. G06F 8/71; G06F 8/60; G06F 11/34; G06F 21/31; G06F 21/60

(52) U.S. Cl. CPC G06F 8/71; G06F 8/60; G06F 11/3457; G06F 21/31; G06F 21/602

(57) ABSTRACT

The present disclosure provides systems and methods for testing the scalability of a commit of an application and the measurement of performance metrics indicating the commit has satisfied a performance threshold. A plurality of mock users of a first commit of an application included in a first stack are simulated and a mocked import queue for the first commit that simulates simultaneous performance of a plurality of actions associated with the application is initiated. Normal network traffic performed by the plurality of mock users is simulated as occurring simultaneously to the plurality of actions simulated using the mocked import queue. A performance metric of the application is measured and, in some embodiments, associated with the first commit.

### CROSS-REFERENCE TO RELATED APPLICATION(S)

This application claims priority to and the benefits of U.S. Provisional Application No. 63/708,185, titled “SCALABILITY TESTING FRAMEWORK” filed on Oct. 16, 2024. The content of the aforementioned application is herein incorporated by reference in its entirety.

### BACKGROUND

Scalability testing is a type of non-functional testing in which the performance of a software application, system, network, or process is tested in terms of its capability to scale up or scale down the size of user request load or other such performance attributes. It can be carried out at a hardware, software, or database level. Scalability testing is defined as the ability of a network, system, application, product, or process to perform a function correctly when changes are made in the size or volume of the system to meet a growing need. It ensures that a software product can manage scheduled increases in user traffic, data volume, and transaction counts frequency while avoiding other errors.

Scalability testing helps determine at what point the software product or the system stops scaling and helps identify the reason behind a failure. The parameters used for this testing differ from one application to another. For example, scalability testing of a web page depends on the number of users, central processing unit (CPU) usage, and network usage, while scalability testing of a web server depends on the number of requests processed.

### BRIEF DESCRIPTION OF THE DRAWINGS

Reference will now be made, by way of example, to the accompanying drawings which show example embodiments of the present application, and in which:

FIG. 1 is a block diagram illustrating a platform, which may be used to implement examples of the present disclosure.

FIG. 2 is a block diagram of a transformer neural network, which may be used in examples of the present disclosure.

FIG. 3 is a block diagram illustrating a hierarchical organization of pages in a workspace.

FIG. 4 is an example scalability testing framework including a main branch, a capacity testing stack, and a production stack.

FIG. 5 is a flow diagram illustrating an example method of replacing a commit of an application based on the satisfaction of a predetermined performance threshold.

FIG. 6 is a flow diagram illustrating an example method of measuring a performance metric of an application.

FIG. 7 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology provides for testing of the scalability of a commit of an application and the automatic deployment of the commit to a publicly accessible environment after measurement of a performance metric has indicated the commit has satisfied a performance threshold. Existing technologies for scalability testing may rely on simplified load testing scenarios that do not adequately represent the complex interactions and varied user behaviors encountered in production environments. These approaches may fail to capture the full range of performance issues that can arise when an application is subjected to high loads and diverse usage patterns. Furthermore, conventional scalability testing frameworks may lack the ability to simultaneously simulate multiple types of actions and network traffic, limiting their effectiveness in predicting how an application will perform under real-world conditions. This can lead to unexpected performance bottlenecks and failures when the application is deployed to production, potentially resulting in poor user experiences and service disruptions.

The present technology addresses these shortcomings by providing a more comprehensive and efficient scalability testing framework. This framework enables the simulation of various user actions and network traffic patterns, allowing for a more accurate assessment of an application's performance under high load conditions. In some embodiments, a plurality of actions are simulated for processing of a commit of an application simultaneously with the simulation of normal network traffic, accurately replicating production scenarios involving a number of users much greater than the current number of public users of an application. In these and other embodiments, the plurality of actions includes the simultaneous import of a plurality of files from a test set, wherein the importation of each file in the test set is repeated multiple times. This repetition allows for arbitrarily high loads to be simulated without the need to store increasingly high numbers of files in the test set.

Furthermore, in some embodiments, performance metrics are measured and associated with a specific commit of an application. This association enables developers to track performance changes across different versions of the application, facilitating the identification of improvements or regressions in scalability. In these and other embodiments, once one or more performance metrics for a commit are determined to meet or exceed a predetermined threshold indicating satisfactory performance of the commit during periods of high load, the commit is automatically deployed to a publicly accessible environment and/or replaces a previous commit of the application. This automation streamlines the deployment process, reducing the risk of human error and accelerating the release of performance-optimized versions of the application.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Block Data Model

The disclosed technology includes a block data model (“block model”). The blocks are dynamic units of information that can be transformed into other block types and move across workspaces. The block model allows users to customize how their information is moved, organized, and shared. Hence, blocks contain information but are not siloed.

Blocks are singular pieces that represent all units of information inside an editor. In one example, text, images, lists, a row in a database, etc., are all blocks in a workspace. The attributes of a block determine how that information is rendered and organized. Every block can have attributes including an identifier (ID), properties, and type. Each block is uniquely identifiable by its ID. The properties can include a data structure containing custom attributes about a specific block. An example of a property is “title,” which stores text content of block types such as paragraphs, lists, and the title of a page. More elaborate block types require additional or different properties, such as a page block in a database with user-defined properties. Every block can have a type, which defines how a block is displayed and how the block's properties are interpreted.

A block has attributes that define its relationship with other blocks. For example, the attribute “content” is an array (or ordered set) of block IDs representing the content inside a block, such as nested bullet items in a bulleted list or the text inside a toggle. The attribute “parent” is the block ID of a block's parent, which can be used for permissions. Blocks can be combined with other blocks to track progress and hold all project information in one place.

A block type is what specifies how the block is rendered in a user interface (UI), and the block's properties and content are interpreted differently depending on that type. Changing the type of a block does not change the block's properties or content—it only changes the type attribute. The information is thus rendered differently or even ignored if the property is not used by that block type. Decoupling property storage from block type allows for efficient transformation and changes to rendering logic and is useful for collaboration.

Blocks can be nested inside of other blocks (e.g., infinitely nested sub-pages inside of pages). The content attribute of a block stores the array of block IDs (or pointers) referencing those nested blocks. Each block defines the position and order in which its content blocks are rendered. This hierarchical relationship between blocks and their render children are referred to herein as a “render tree.” In one example, page blocks display their content in a new page, instead of rendering it indented in the current page. To see this content, a user would need to click into the new page.

In the block model, indentation is structural (e.g., reflects the structure of the render tree). In other words, when a user indents something, the user is manipulating relationships between blocks and their content, not just adding a style. For example, pressing Indent in a content block can add that block to the content of the nearest sibling block in the content tree.

Blocks can inherit permissions of blocks in which they are located (which are above them in the tree). Consider a page: to read its contents, a user must be able to read the blocks within that page. However, there are two reasons one cannot use the content array to build the permissions system. First, blocks are allowed to be referenced by multiple content arrays to simplify collaboration and a concurrency model. But because a block can be referenced in multiple places, it is ambiguous which block it would inherit permissions from. The second reason is mechanical. To implement permission checks for a block, one needs to look up the tree, getting that block's ancestors all the way up to the root of the tree (which is the workspace). Trying to find this ancestor path by searching through all blocks' content arrays is inefficient, especially on the client. Instead, the model uses an “upward pointer” the parent attribute—for the permission system. The upward parent pointers and the downward content pointers mirror each other.

A block's life starts on the client. When a user takes an action in the interface—typing in the editor, dragging blocks around a page—these changes are expressed as operations that create or update a single record. The “records” refer to persisted data, such as blocks, users, workspaces, etc. Because many actions usually change more than one record, operations are batched into transactions that are committed (or rejected) by the server as a group.

Creating and updating blocks can be performed by, for example, pressing Enter on a keyboard. First, the client defines all the initial attributes of the block, generating a new unique ID, setting the appropriate block type (to_do), and filling in the block's properties (an empty title, and checked: [[“No”]]). The client builds operations to represent the creation of a new block with those attributes. New blocks are not created in isolation: blocks are also added to their parent's content array, so they are in the correct position in the content tree. As such, the client also generates an operation to do so. All these individual change operations are grouped into a transaction. Then, the client applies the operations in the transaction to its local state. New block objects are created in memory and existing blocks are modified. In native apps, the model caches all records that are accessed locally in an LRU (least recently used) cache on top of SQLite or IndexedDB, referred to as RecordCache. When records are changed on a native app, the model also updates the local copies in RecordCache. The editor re-renders to draw the newly created block onto the display. At the same time, the transaction is saved into TransactionQueue, the part of the client responsible for sending all transactions to the model's servers so that the data is persisted and shared with collaborators. TransactionQueue stores transactions safely in IndexedDB or SQLite (depending on the platform) until they are persisted by the server or rejected.

A block can be saved on a server to be shared with others. Usually, TransactionQueue sits empty, so the transaction to create the block is sent to the server in an application programming interface (API) request. In one example, the transaction data is serialized to JSON and posted to the /saveTransactions API endpoint. SaveTransactions gets the data into source-of-truth databases, which store all block data as well as other kinds of persisted records. Once the request reaches the API server, all the blocks and parents involved in the transaction are loaded. This gives a “before” picture in memory. The block model duplicates the “before” data that had just been loaded in memory. Next, the block model applies the operations in the transaction to the new copy to create the “after” data. Then the model uses both “before” and “after” data to validate the changes for permissions and data coherency. If everything checks out, all created or changed records are committed to the database—meaning the block has now officially been created. At this point, a “success” HTTP response to the original API request is sent by the client. This confirms that the client knows the transaction was saved successfully and that it can move on to saving the next transaction in the TransactionQueue. In the background, the block model schedules additional work depending on the kind of change made for the transaction. For example, the block model can schedule version history snapshots and indexing block text for a Quick Find function. The block model also notifies MessageStore, which is a real-time updates service, about the changes that were made.

The block model provides real-time updates to, for example, almost instantaneously show new blocks to members of a teamspace. Every client can have a long-lived WebSocket connection to the MessageStore. When the client renders a block (or page, or any other kind of record), the client subscribes to changes of that record from MessageStore using the WebSocket connection. When a team member opens the same page, the member is subscribed to changes of all those blocks. After changes have been made through the saveTransactions process, the API notifies MessageStore of new recorded versions. MessageStore finds client connections subscribed to those changing records and passes on the new version through their WebSocket connection. When a team member's client receives version update notifications from MessageStore, it verifies that version of the block in its local cache. Because the versions from the notification and the local block are different, the client sends a syncRecordValues API request to the server with the list of outdated client records. The server responds with the new record data. The client uses this response data to update the local cache with the new version of the records, then re-renders the user interface to display the latest block data.

Blocks can be shared instantaneously with collaborators. In one example, a page is loaded using only local data. On the web, block data is pulled from being in memory. On native apps, loading blocks that are not in memory are loaded from the RecordCache persisted storage. However, if missing block data is needed, the data is requested from an API. The API method for loading the data for a page is referred to herein as loadPageChunk; it descends from a starting point (likely the block ID of a page block) down the content tree and returns the blocks in the content tree plus any dependent records needed to properly render those blocks. Several layers of caching for loadPageChunk are used, but in the worst case, this API might need to make multiple trips to the database as it recursively crawls down the tree to find blocks and their record dependencies. All data loaded by loadPageChunk is put into memory (and saved in the RecordCache if using the app). Once the data is in memory, the page is laid out and rendered using React.

### Software Platform

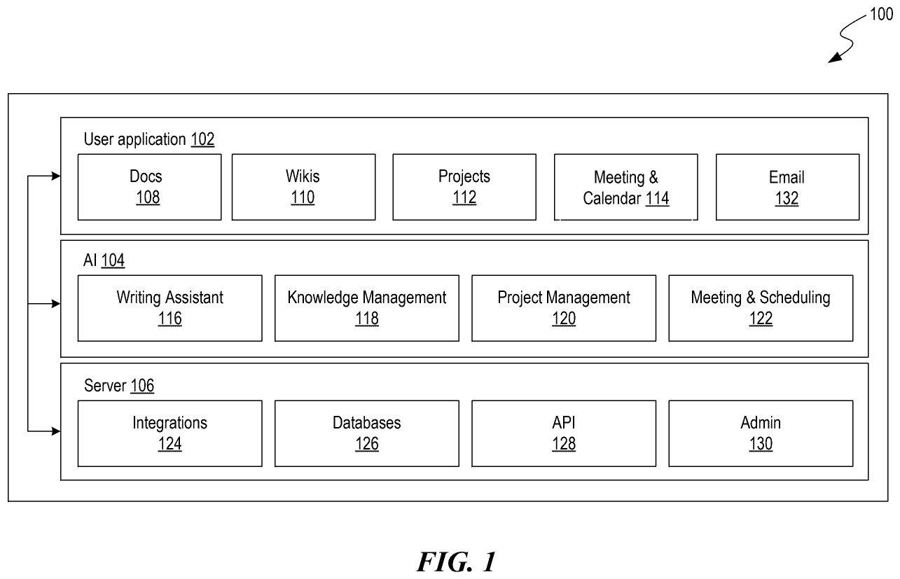

FIG. 1 is a block diagram of an example platform 100. The platform 100 provides users with an all-in-one workspace for data and project management. The platform 100 can include a user application 102, an artificial intelligence (AI) tool 104, and a server 106. The user application 102, the AI tool 104, and the server 106 are in communication with each other via a network.

In some implementations, the user application 102 is a cross-platform software application configured to work on several computing platforms and web browsers. The user application 102 can include a variety of templates. A template refers to a prebuilt page that a user can add to a workspace within the user application 102. The templates can be directed to a variety of functions. Exemplary templates include a docs template 108, a wikis template 110, a projects template 112, a meeting and calendar template 114, and an email template 132. In some implementations, a user can generate, save, and share customized templates with other users.

The user application 102 templates can be based on content “blocks.” For example, the templates of the user application 102 include a predefined and/or pre-organized set of blocks that can be customized by the user. Blocks are content containers within a template that can include text, images, objects, tables, maps, emails, and/or other pages (e.g., nested pages or sub-pages). Blocks can be assigned to certain properties. The blocks are defined by boundaries having dimensions. The boundaries can be visible or non-visible for users. For example, a block can be assigned as a text block (e.g., a block including text content), a heading block (e.g., a block including a heading), or a sub-heading block having a specific location and style to assist in organizing a page. A block can be assigned as a list block to include content in a list format. A block can be assigned as an AI prompt block (also referred to as a “prompt block”) that enables a user to provide instructions (e.g., prompts) to the AI tool 104 to perform functions. A block can also be assigned to include audio, video, or image content.

A user can add, edit, and remove content from the blocks. The user can also organize the content within a page by moving the blocks around. In some implementations, the blocks are shared (e.g., by copying and pasting) between the different templates within a workspace. For example, a block embedded within multiple templates can be configured to show edits synchronously.

The docs template 108 is a document generation and organization tool that can be used for generating a variety of documents. For example, the docs template 108 can be used to generate pages that are easy to organize, navigate, and format. The wikis template 110 is a knowledge management application having features similar to the pages generated by the docs template 108 but that can additionally be used as a database. The wikis template 110 can include, for example, tags configured to categorize pages by topic and/or include an indication of whether the provided information is verified to indicate its accuracy and reliability. The projects template 112 is a project management and note-taking software tool. The projects template 112 can allow the users, either as individuals or as teams, to plan, manage, and execute projects in a single forum. The meeting and calendar template 114 is a tool for managing tasks and timelines. In addition to traditional calendar features, the meeting and calendar template 114 can include blocks for categorizing and prioritizing scheduled tasks, generating to-do and action item lists, tracking productivity, etc. The various templates of the user application 102 can be included under a single workspace and include synchronized blocks. For example, a user can update a project deadline on the projects template 112, which can be automatically synchronized to the meeting and calendar template 114. The various templates of the user application 102 can be shared within a team, allowing multiple users to modify and update the workspace concurrently.

The email template 132 allows the users to customize their inbox by representing the inbox as a customizable database where the user can add custom columns and create custom views with layouts. One view can include multiple layouts including a calendar layout, a summary layout, and an urgent information layout. Each view can include a customized structure including custom criteria, custom properties, and custom actions. The custom properties can be specific to a view such as AI-extracted properties and/or heuristic-based properties. The custom actions can trigger automatically when a message enters the view. The custom actions can include deterministic rules like “Archive this,” or assistant workflows like responding to support messages by searching user applications 102 or filing support tickets. In addition, the view can include actions, such as buttons, that are custom to the view and perform operations on the messages in the inbox. Only the customized structure can be shared with other users of the system, or both the customized structure and the messages can be shared.

The integration of the docs template 108, the wikis template 110, the projects template 112, the meeting and calendar template 114, and the email template 132 enables linking and embedding of templates within other templates. For example, an email sent from an email address within the platform 100 to another email address within the platform 100 can include an embedding of a document within the platform 100, or an embedding of a block within the document. In another example, a wiki can link to a meeting within the calendar.

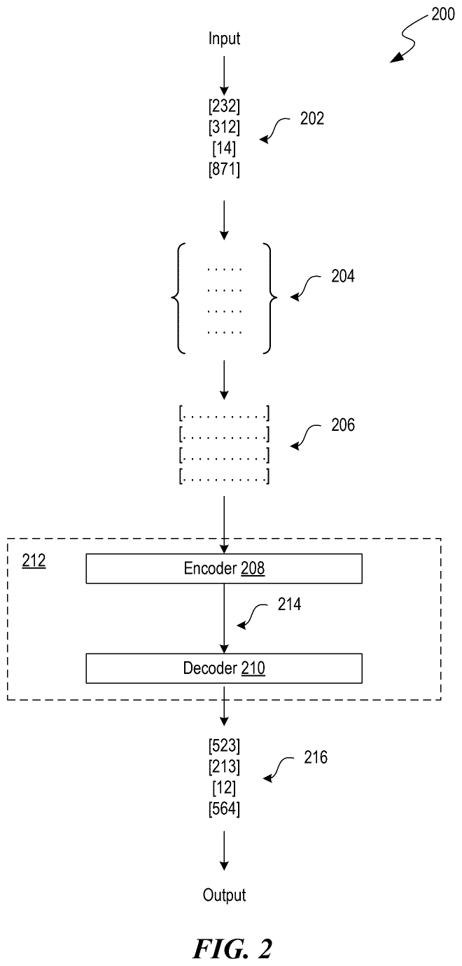

The AI tool 104 is an integrated AI assistant that enables AI-based functions for the user application 102. In one example, the AI tool 104 is based on a neural network architecture, such as the transformer 212 described in relation to FIG. 2. The AI tool 104 can interact with blocks embedded within the templates on a workspace of the user application 102. For example, the AI tool 104 can include a writing assistant tool 116, a knowledge management tool 118, a project management tool 120, and a meeting and scheduling tool 122. The different tools of the AI tool 104 can be interconnected and interact with different blocks and templates of the user application 102.

The writing assistant tool 116 can operate as a generative AI tool for creating content for the blocks in accordance with instructions received from a user. Creating the content can include, for example, summarizing, generating new text, or brainstorming ideas. For example, in response to a prompt received as a user input that instructs the AI to describe what the climate is like in New York, the writing assistant tool 116 can generate a block including text that describes the climate in New York. As another example, in response to a prompt that requests ideas on how to name a pet, the writing assistant tool 116 can generate a block including a list of creative pet names. The writing assistant tool 116 can also operate to modify existing text. For example, the writing assistant can shorten, lengthen, or translate existing text, correct grammar and typographical errors, or modify the style of the text (e.g., a social media style versus a formal style).

The knowledge management tool 118 can use AI to categorize, organize, and share knowledge included in the workspace. In some implementations, the knowledge management tool 118 can operate as a question-and-answer assistant. For example, a user can provide instructions on a prompt block to ask a question. In response to receiving the question, the knowledge management tool 118 can provide an answer to the question, for example, based on information included in the wikis template 110. The project management tool 120 can provide AI support for the projects template 112. The AI support can include autofilling information based on changes within the workspace or automatically tracking project development. For example, the project management tool 120 can use AI for task automation, data analysis, real-time monitoring of project development, allocation of resources, and/or risk mitigation. The meeting and scheduling tool 122 can use AI to organize meeting notes, unify meeting records, list key information from meeting minutes, and/or connect meeting notes with deliverable deadlines.

The server 106 can include various units (e.g., including compute and storage units) that enable the operations of the AI tool 104 and workspaces of the user application 102. The server 106 can include an integrations unit 124, an application programming interface (API) 128, databases 126, and an administration (admin) unit 130. The databases 126 are configured to store data associated with the blocks. The data associated with the blocks can include information about the content included in the blocks, the function associated with the blocks, and/or any other information related to the blocks. The API 128 can be configured to communicate the block data between the user application 102, the AI tool 104, and the databases 126. The API 128 can also be configured to communicate with remote server systems, such as AI systems. For example, when a user performs a transaction within a block of a template of the user application 102 (e.g., in a docs template 108), the API 128 processes the transaction and saves the changes associated with the transaction to the database 126. The integrations unit 124 is a tool connecting the platform 100 with external systems and software platforms. Such external systems and platforms can include other databases (e.g., cloud storage spaces), messaging software applications, or audio or video conference applications. The administration unit 130 is configured to manage and maintain the operations and tasks of the server 106. For example, the administration unit 130 can manage user accounts, data storage, security, performance monitoring, etc.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification, etc.) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online web pages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses large language models (LLMs).

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as RNN-based language models.

FIG. 2 is a block diagram 200 of an example transformer 212. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as RNN-based language models.

The transformer 212 includes an encoder 208 (which can include one or more encoder layers/blocks connected in series) and a decoder 210 (which can include one or more decoder layers/blocks connected in series). Generally, the encoder 208 and the decoder 210 each include multiple neural network layers, at least one of which can be a self-attention layer. The parameters of the neural network layers can be referred to as the parameters of the language model.

The transformer 212 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 212 is trained to perform certain functions on other input formats than natural language input. For example, the input can include objects, images, audio content, or video content, or a combination thereof.

The transformer 212 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 2 illustrates an example of how the transformer 212 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 2, a short sequence of tokens 202 corresponding to the input text is illustrated as input to the transformer 212. Tokenization of the text sequence into the tokens 202 can be performed by some pre-processing tokenization module such as, for example, a byte-pair encoding tokenizer (the “pre” referring to the tokenization occurring prior to the processing of the tokenized input by the LLM), which is not shown in FIG. 2 for brevity. In general, the token sequence that is inputted to the transformer 212 can be of any length up to a maximum length defined based on the dimensions of the transformer 212. Each token 202 in the token sequence is converted into an embedding vector 206 (also referred to as “embedding 206”).

An embedding 206 is a learned numerical representation (such as, for example, a vector) of a token that captures some semantic meaning of the text segment represented by the token 202. The embedding 206 represents the text segment corresponding to the token 202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 206 corresponding to the “write” token will be closer to another embedding corresponding to the “jot down” token in the vector space as compared to the distance between the embedding 206 corresponding to the “write” token and another embedding corresponding to the “summary” token.

The vector space can be defined by the dimensions and values of the embedding vectors. Various techniques can be used to convert a token 202 to an embedding 206. For example, another trained ML model can be used to convert the token 202 into an embedding 206. In particular, another trained ML model can be used to convert the token 202 into an embedding 206 in a way that encodes additional information into the embedding 206 (e.g., a trained ML model can encode positional information about the position of the token 202 in the text sequence into the embedding 206). In some implementations, the numerical value of the token 202 can be used to look up the corresponding embedding in an embedding matrix 204, which can be learned during training of the transformer 212.

The generated embeddings 206 are input into the encoder 208. The encoder 208 serves to encode the embeddings 206 into feature vectors 214 that represent the latent features of the embeddings 206. The encoder 208 can encode positional information (i.e., information about the sequence of the input) in the feature vectors 214. The feature vectors 214 can have very high dimensionality (e.g., on the order of thousands or tens of thousands), with each element in a feature vector 214 corresponding to a respective feature. The numerical weight of each element in a feature vector 214 represents the importance of the corresponding feature. The space of all possible feature vectors 214 that can be generated by the encoder 208 can be referred to as a latent space or feature space.

Conceptually, the decoder 210 is designed to map the features represented by the feature vectors 214 into meaningful output, which can depend on the task that was assigned to the transformer 212. For example, if the transformer 212 is used for a translation task, the decoder 210 can map the feature vectors 214 into text output in a target language different from the language of the original tokens 202. Generally, in a generative language model, the decoder 210 serves to decode the feature vectors 214 into a sequence of tokens. The decoder 210 can generate output tokens 216 one by one. Each output token 216 can be fed back as input to the decoder 210 in order to generate the next output token 216. By feeding back the generated output and applying self-attention, the decoder 210 can generate a sequence of output tokens 216 that has sequential meaning (e.g., the resulting output text sequence is understandable as a sentence and obeys grammatical rules). The decoder 210 can generate output tokens 216 until a special [EOT] token (indicating the end of the text) is generated. The resulting sequence of output tokens 216 can then be converted to a text sequence in post-processing. For example, each output token 216 can be an integer number that corresponds to a vocabulary index. By looking up the text segment using the vocabulary index, the text segment corresponding to each output token 216 can be retrieved, the text segments can be concatenated together, and the final output text sequence can be obtained.

In some implementations, the input provided to the transformer 212 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco? ” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API (e.g., the API 128 in FIG. 1). As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Hierarchical Organizational Blocks in a Workspace

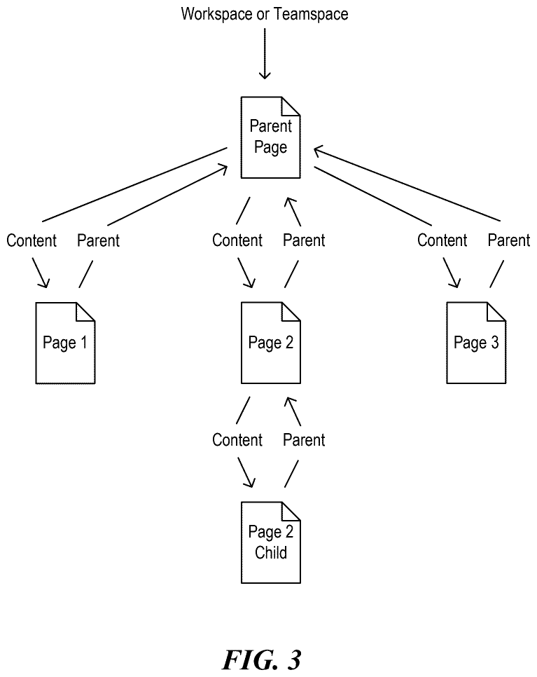

FIG. 3 is a block diagram illustrating a hierarchical organization of pages in a workspace. As described with respect to the block data model of the present technology, a workspace can include multiple pages (e.g., page blocks). The pages (e.g., including parent pages and child or nested pages) can be arranged hierarchically within the workspace or one or more teamspaces, as shown in FIG. 3. The page can include a block such as tabs, lists, images, tables, etc.

A teamspace can refer to a collaborative space associated with a team or an organization that is hierarchically below a workspace. For example, a workspace can include a teamspace accessible by all users of an organization and multiple teamspaces that are accessible by users of different teams. Accessibility generally refers to creating, editing, and/or viewing content (e.g., pages) included in the workspace or the one or more teamspaces.

In the hierarchical organization illustrated in FIG. 3, a parent page (e.g., “Parent Page”) is located hierarchically below the workspace or a teamspace. The parent page includes three children pages (e.g., “Page 1,” “Page 2,” and “Page 3”). Each of the child pages can further include subpages (e.g., “Page 2 Child,” which is a grandchild of “Parent Page” and child of “Page 2”). The “Content” arrows in FIG. 3 indicate the relationship between the parents and children while the “Parent” arrows indicate the inheritance of access permissions. The child pages inherit access permission from the (immediate) parent page under which they are located hierarchically (e.g., which is above them in the tree). For example, “Page 2” inherited the access permission of the “Parent Page” as a default when it was created under its parent page. Similarly, “Page 2 Child” inherited the access permission of the parent page as a default when it was created under its parent page. “Parent Page,” “Page 2,” and “Page 2 Child” thereby have the same access permission within the workspace.

The relationships and organization of the content can be modified by changing the location of the pages. For example, when a child page is moved to be under a different parent, the child page's access permission modifies to correspond to the access permission of the new parent. Also, when the access permission of “Parent Page” is modified, the access permission of “Page 1,” “Page 2,” and “Page 3” can be automatically modified to correspond to the access permission of “Parent Page” based on the inheritance character of access permissions.

In contrast, however, a user can modify the access permission of the children independently of their parents. For example, the user can modify the access permission of “Page 2 Child” in FIG. 3 so that it is different from the access permission of “Page 2” and “Parent Page.” The access permission of “Page 2 Child” can be modified to be broader or narrower than the access permission of its parents. As an example, “Page 2 Child” can be shared on the internet while “Page 2” is only shared internally to the users associated with the workspace. As another example, “Page 2 Child” can be shared only with an individual user while “Page 2” is shared with a group of users (e.g., a team of the organization associated with the workspace). In some implementations, the hierarchical inheritance of the access permissions described herein can be modified from the previous description. For example, the access permissions of all the pages (parent and children) can be defined as independently changeable.

### Example Scalability Testing Framework

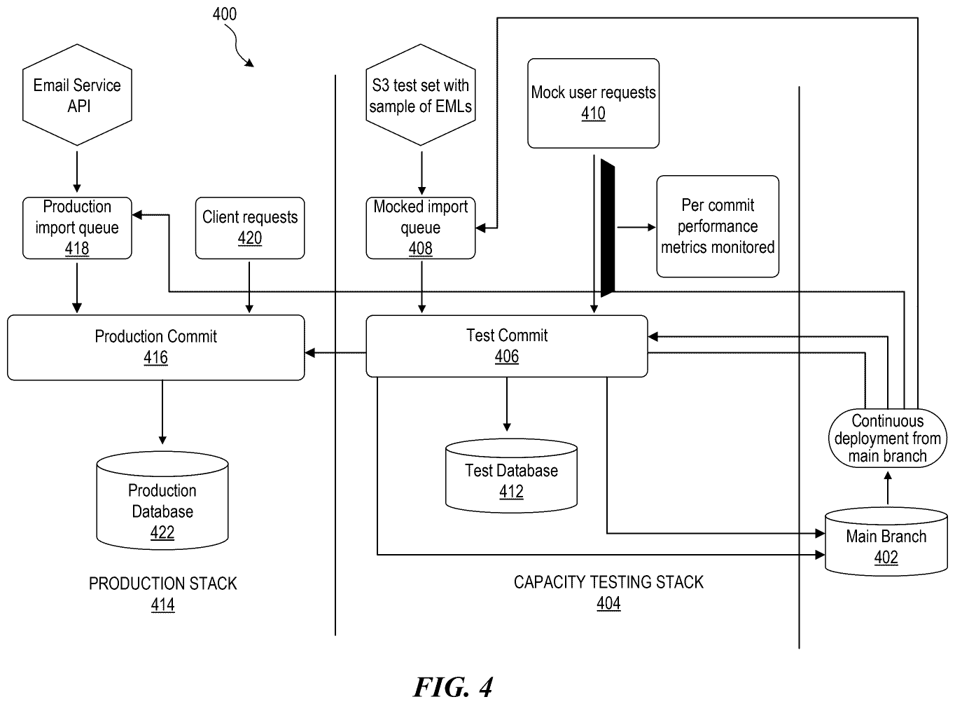

FIG. 4 is an example scalability testing framework 400 including a main branch 402, a capacity testing stack 404, and a production stack 414. In some embodiments, the scalability testing framework 400 is used for testing the scalability of a commit of an application deployed from a main branch and deploying that commit in an environment where the commit is accessible for public use (e.g., by public users who are not developers of the application) after measurement of a performance metric has indicated the commit has satisfied a performance threshold.

The main branch 402 is a code repository where a version or commit of a software intended for public use is uploaded. For example, the main branch 402 may be associated with one or more side branches representing development versions of the same code which, when approved, are merged into the main branch 402. The main branch 402 continuously deploys the latest commit of the code it stores to the capacity testing stack 404 and, once satisfactory performance is determined within the capacity testing stack 404, deploys that commit to the production stack 414 as well. More details regarding the capacity testing stack 404 and production stack 414 are provided below.

The capacity testing stack 404 of the scalability testing framework 400 includes a test commit 406, a mocked import queue 408, a plurality of mock user requests 410, and a test database 412. The capacity testing stack 404 is where a test commit 406 of an application is received from the main branch 402 to be tested for the commit's capacity to perform when scaled to a large number of users. The test commit 406 is the latest commit received from the main branch 402 and represents a version of the application that is ultimately intended for public use within the production stack 414 after its performance has been verified in the capacity testing stack 404.

The mocked import queue 408 and mock user requests 410 of the capacity testing stack 404 are used to test the performance of the test commit 406 under high load. The mocked import queue 408 simulates the simultaneous occurrence of a plurality of actions to be processed by the test commit 406, such as the simultaneous import of a plurality of files, the simultaneous signup of a plurality of users, or the simultaneous receipt of a plurality of read operations (e.g., indications that an email or other file has been read by a user). For example, as depicted in FIG. 4, the mocked import queue 408 uses a test set of email files (EMLs) stored by the Amazon Simple Storage Service (S3) to simulate the simultaneous import of a plurality of emails into the test commit 406. In some embodiments, the mocked import queue 408 will import each file in a plurality of imported files (e.g., the S3 test set) multiple times to simulate a greater number of simultaneous actions than the number of files in the plurality of imported files. Thus, the capacity of the test commit 406 can be tested under arbitrarily high loads that can be scaled upwards without the need to store increasingly high numbers of files in a test set to be used by the mocked import queue 408.

The mock user requests 410 are requests simulating normal network traffic passing to the test commit 406. Normal network traffic is network traffic placing a computational load on the test commit 406 that is the same as or generally similar to the average computational load the application receives when deployed to the public (e.g., via the production stack 414). In some embodiments, the mock user requests 410 are performed by a plurality of mock users of the test commit 406 simulated within the capacity testing stack 404 (e.g., by generating random GraphQL API calls). In these and other embodiments, the mock user requests 410 may include requests to open, read, or modify a file (e.g., an EML file). In some embodiments, the mock user requests 410 are simulated simultaneously to the plurality of actions simulated using the mocked import queue 408, allowing the capacity testing stack 404 to test the ability of the test commit 406 to handle normal network traffic while simultaneously handling a plurality of other actions demanding a high computational load.

The capacity testing stack 404 also includes a test database 412 for storing data associated with operation of the test commit 406. For example, the test database 412 may store files imported by the mocked import queue 408 or data uploaded by one of the mock user requests 410. In some embodiments, the test database 412 is queried during operation of the test commit 406 for the retrieval of data (e.g., via a GraphQL API call).

In some embodiments, the performance of the test commit under the conditions described above is measured by the capacity testing stack 404. As depicted in FIG. 4, per commit performance metrics are measured for the test commit 406 while the mock user requests 410 are being received, meaning that the performance metrics measured are associated exclusively with the test commit 406. Furthermore, metrics previously measured for other commits are not associated with the test commit 406, allowing changes in performance between the test commit 406 and other commits to be isolated. In some embodiments, the performance metrics monitored may include one or more of a response time across endpoints for a data query call (e.g., an API call representing a request for specific data from the test database 412, such as a GraphQL API call), a rate at which the test commit 406 processes queued user requests, a measurement of memory, central processing unit (CPU), or network bandwidth consumption by the test commit 406, a measurement of cache performance (e.g., a determination that state-depending operations occur during the intended states of the test commit 406), a database performance measurement (e.g., a measurement of the query response time, read/write latency, and/or connection counts associated with the test database 412), or an autoscaling performance measurement indicating whether resources of the test commit 406 automatically scale in response to increased computational demand. The performance metrics may additionally include other metrics indicative of the performance of the test commit under high load.

In some embodiments, a predetermined performance threshold is associated with one or more of the measured performance metrics. This threshold is a numerical value that, when exceeded, indicates the test commit 406 exhibits satisfactory performance regarding the measured performance metric during periods of high load. For example, the predetermined performance threshold may be determined by a developer of the application or represent an industry performance standard. In some embodiments, when one or more performance thresholds are met or exceeded, the main branch 402 is signaled by the capacity testing stack 404 that the test commit 406 is ready to be deployed to the public in the production stack 414.

The production stack 414 of the scalability testing framework 400 includes a production commit 416, a production import queue 418, a plurality of client requests 420, and a production database 422. The production stack 414 is generally similar to the capacity testing stack 404, but allows a production commit 416 of the application to be accessible by the public after being deployed to the production stack 414 from the main branch 402. As described above, in some embodiments, a production commit 416 of an application is received from the main branch 402 to be deployed to the public after the performance of the commit has been measured in the capacity testing stack 404. Thus, in such embodiments, the test commit 406 and production commit 416 may be identical until a change to the code in the main branch 402 occurs, triggering deployment of this new commit as the test commit 406 in the capacity testing stack 404. This new commit will not be deployed to the production stack 414 as the production commit 416 until the capacity testing stack 404 verifies that the applicable performance thresholds are satisfied.

The production import queue 418 of the production stack 414 imports data into the production commit 416 and/or serves as a queue for other actions to be processed by the production commit 416, such as user signups or read operations. The production import queue 418 is analogous to the mocked import queue 408 but imports data and queues actions based on real behavior of public users of the application rather than based on a test set of data and simulated actions. For example, as depicted in FIG. 4, the production import queue 418 imports data received from an API call of an external email provider (e.g., Gmail) rather than from an S3 test set, as is the case for the mocked import queue 408. Additionally, also as depicted in FIG. 4, the production import queue 418 may be continuously deployed from the latest version of code in the main branch 402.

Client requests 420 are requests received from public users of the production commit 416 for the production commit 416 to process. In some embodiments, this processing occurs simultaneously to the processing of actions from the production import queue 418. In embodiments where the commit that eventually becomes the production commit 416 is first tested under high load in the capacity testing stack 404, the probability of errors in performance of the production commit 416 while processing client requests 420 and/or actions from the production import queue 418 is reduced.

The production stack 414 also includes a production database 422 for storing data associated with operation of the production commit 416. For example, the production database 422 may store files imported by the production import queue 418 or data uploaded by a client request 420. In some embodiments, the production database 422 is queried during operation of the production commit 416 for the retrieval of data (e.g., via a GraphQL API call).

### Example Methods Involving Performance Metric Measurements

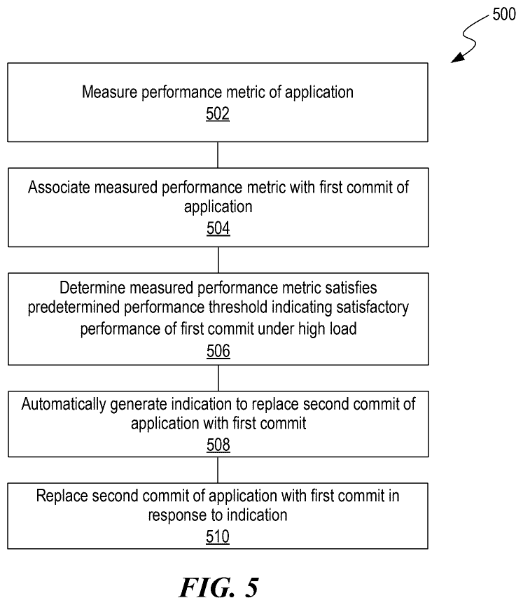

FIG. 5 is a flow diagram illustrating an example method of replacing a commit 500 of an application based on the satisfaction of a predetermined performance threshold. In operation 502, a performance metric of an application is measured. In some embodiments, such as the scalability testing framework 400 of FIG. 4, the performance metric is associated with performance of the application during simulation of normal network traffic (e.g., traffic performed by a plurality of mock users) occurring simultaneously to a plurality of actions (e.g., actions simulated using a mocked import queue 408). In these and other embodiments, the measured performance metric may be a performance metric described in relation to the capacity testing stack 404 of FIG. 4 above, or another metric indicative of the performance of the application under high load.

In operation 504, the measured performance metric, or value of the performance metric measured in operation 502, is associated with a first commit of the application. The first commit of the application is the version of the application for which the performance metric is measured and may be distinguished from other commits of the application comprising different code. For example, the first commit may be a test commit 406 as described in relation to FIG. 4 above and may differ from a production commit 416 and/or a development commit of the application not represented in the main branch 402. Associating the measured performance metric with the first commit aids developers of the application in determining that the measured performance metric represents the performance of the first commit rather than another commit and allows performance of the first commit to be compared to other commits.

In operation 506, a determination is made that the measured performance metric satisfies a predetermined performance threshold indicating satisfactory performance of the first commit under high load. In some embodiments, the predetermined performance threshold is the same as or generally similar to the predetermined performance threshold described in relation to FIG. 4 above. Satisfying the predetermined performance threshold includes meeting or exceeding the value of the threshold.

In operation 508, an indication to replace a second commit of the application with the first commit is automatically generated in response to the determination that the measured performance metric satisfies a predetermined performance threshold. In operation 510, the second commit is replaced with the first commit in response to the indication. The second commit is a commit of the application that is different from the first commit and, in some embodiments, may be a production commit 416 as described in relation to FIG. 4 above or another commit accessible to public users. In these and other embodiments, the second commit may be included in a second stack including the components of a capacity testing stack 404, a production stack 414, and/or other software components.

In some embodiments, such as the embodiment depicted in FIG. 4 above, the indication of operation 508 is automatically generated within a capacity testing stack 404 and sent to a main branch 402, with the main branch 402 deploying the first commit to a production stack 414 to replace a second commit (e.g., a production commit 416) in response to receiving the indication. Automatically generating the indication and subsequently replacing the second commit allows the second commit to be updated with a version of the application (e.g., the first commit) that has been verified to satisfy the standard of satisfactory performance under high load represented by the predetermined performance threshold without the need for manual oversight, thereby improving the speed at which updates are deployed and reducing the probability of human error in deploying a faulty version of the application.

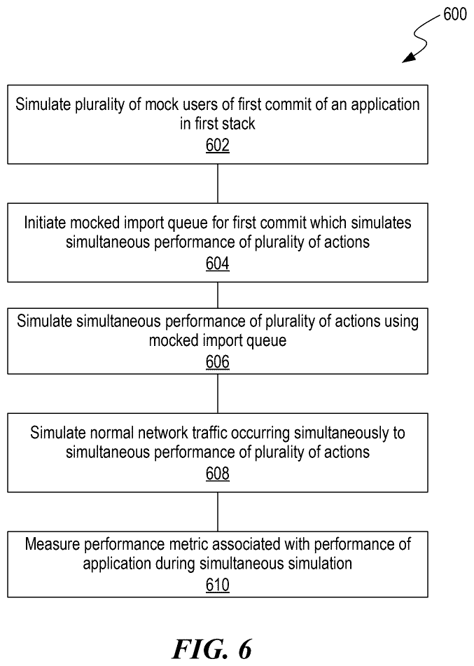

FIG. 6 is a flow diagram illustrating an example method of measuring a performance metric of an application 600. In operation 602, a plurality of mock users of a first commit of an application in a first stack is simulated. The plurality of mock users is a collection of simulated users configured to perform mock requests that are received by the first commit. For example, the plurality of mock users may be simulated using dummy authentication tokens representing the authentication tokens required to set up a user account for an external email provider (e.g., Gmail). Using dummy authentication tokens instead of real authentication tokens from an external email provider reduces the number of API calls made to the external email provider while testing the capacity of the first commit, conserving both economic and computational resources and reducing the probability of exceeding applicable API quotas. In some embodiments, the plurality of mock users perform mock user requests 410 received by a test commit 406 in a capacity testing stack 404, as described in relation to FIG. 4 above. However, in other embodiments, the first commit may be another commit of the application deployed in an environment other than a capacity testing stack 404.

In operation 604, a mocked import queue for the first commit which simulates simultaneous performance of a plurality of actions using a mocked import queue is initiated. In some embodiments, the mocked import queue is generally similar to the mocked import queue 408 as described in relation to FIG. 4 above, except that the mocked import queue simulates the simultaneous occurrence of a plurality of actions to be processed by the first commit, which need not be a test commit 406. In these and other embodiments, the mocked import queue may perform analogous logic to a corresponding production import queue for a second commit of the application, excluding an API call made during operation of the production import queue. In this way, the performance of the production import queue may be simulated by the mocked import queue without API calls to external applications being made, reducing both economic and computational costs associated with API calls and reducing the probability of exceeding applicable API quotas.

In operation 606, the simultaneous performance of the plurality of actions is simulated using the mocked import queue. In some embodiments, one or more performance metrics associated with the performance of the first commit while processing the plurality of actions are measured. For example, the performance metrics may include one or more of the performance metrics described in relation to the capacity testing stack 404 of FIG. 4 above. Such a measurement allows for comparison of the performance of the first commit before and after the addition of normal network traffic, as described below.

In operation 608, normal network traffic occurring simultaneously to the simultaneous performance of the plurality of actions is simulated. In some embodiments, the normal network traffic is the same as or generally similar to the normal network traffic as described in relation to FIG. 4 above, and likewise may be performed by a plurality of mock users. Simulating the normal network traffic and plurality of actions simultaneously allows the ability of the first commit to handle normal network traffic while simultaneously handling a plurality of other actions demanding a high computational load to be evaluated.

In operation 610, a performance metric associated with the performance of the application during the simultaneous simulation of the plurality of actions and the normal network traffic is measured. Measuring the performance metric during the simultaneous simulation of the plurality of actions and the normal network traffic allows for evaluation of whether the first commit is ready to be deployed to a public environment in which the first commit may receive large volumes of traffic and client requests simultaneously. Furthermore, it allows for comparison to performance of other commits and/or the first commit itself under periods of less computational load, such as the simulation of the plurality of actions without the normal network traffic. In some embodiments, the performance metric may be a performance metric described in relation to the capacity testing stack 404 of FIG. 4 above. In these and other embodiments, the performance metric may be associated with the first commit as described in relation to operation 504 of FIG. 5 above and the remaining operations 506-510 of FIG. 5 may also be carried out such that a second commit of the application is replaced with the first commit. This automatic replacement allows the second commit to be updated with a version of the application (e.g., the first commit) that has been verified to satisfy the standard of satisfactory performance under high load without the need for manual oversight, thereby improving the speed at which updates are deployed and reducing the probability of human error in deploying a faulty version of the application.

### Computer System

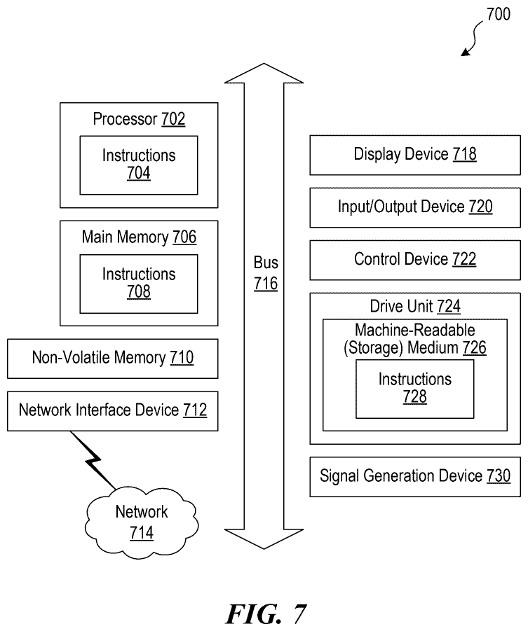

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computer system 700 can share a similar architecture as that of a server computer, personal computer (PC), tablet computer, mobile telephone, wearable electronic device, network-connected (“smart”) device (e.g., a television or home assistant device), augmented reality/virtual reality (AR/VR) system (e.g., head-mounted display), or any electronic device capable of executing a set of instructions that specify action(s) to be taken by the computer system 700. In some implementations, the computer system 700 can be an embedded computer system, a system-on-chip (SOC), a single-board computer (SBC) system, or a distributed system such as a mesh of computer systems or include one or more cloud components in one or more networks. Where appropriate, one or more computer systems 700 can perform operations in real time, near real time, or in batch mode.

The network interface device 712 enables the computer system 700 to mediate data in a network 714 with an entity that is external to the computer system 700 through any communication protocol supported by the computer system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable medium 726 can include any medium that is capable of storing, encoding, or carrying a set of instructions for execution by the computer system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computer system 700 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” or any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A non-transitory, computer-readable storage medium comprising instructions recorded thereon, wherein the instructions, when executed by at least one data processor of a system, cause the system to:
simulate a plurality of mock users of a first commit of an application included in a first stack,
wherein a second commit of the application is accessible to public users and included in a second stack, and
wherein dummy authentication tokens are used to simulate the plurality of mock users;
simulate, using a mocked import queue for the first commit of the application, simultaneous performance of a plurality of actions associated with the application,
wherein the mocked import queue performs analogous logic to a corresponding production import queue for the second commit of the application, excluding an application programming interface (API) call made during operation of the production import queue;
simulate normal network traffic performed by the plurality of mock users occurring simultaneously to the plurality of actions simulated using the mocked import queue;
measure a performance metric associated with the application,
wherein the performance metric is one of a response time of the application to a data query call, a rate at which the application processes queued requests from users, a memory usage measurement, a central processing unit (CPU) usage measurement, a network bandwidth consumption measurement, a cache performance measurement, a database performance measurement, or an autoscaling performance measurement;
associate the measured performance metric with the first commit of the application;
determine that the measured performance metric meets or exceeds a predetermined performance threshold indicating satisfactory performance during periods of high load; and
in response to said determination, automatically generate an indication to replace the second commit of the application with the first commit.

2. The non-transitory, computer-readable storage medium of claim 1, further comprising instructions to:
upload a new commit of the application to the first stack as the first commit via a main branch,
wherein the main branch stores the new commit of the application; and
automatically upload, via the main branch, the new commit of the application to the second stack in response to the indication to replace the second commit of the application with the first commit,
thereby allowing the second commit of the application to be automatically updated to match the new commit after the new commit is determined to meet or exceed the predetermined performance threshold.

3. The non-transitory, computer-readable storage medium of claim 1, wherein:
the production import queue is a queue for importing emails from an external email provider; and
the mocked import queue is used to simulate simultaneous importation of a plurality of email files from a test set,
wherein each email file in the plurality of email files is imported one or more times.

4. The non-transitory, computer-readable storage medium of claim 1, wherein:
the normal network traffic is simulated by generating random GraphQL API calls from users in the plurality of mock users; and
the plurality of actions are simulated actions by the plurality of mock users.

5. A system comprising:
at least one hardware processor; and
at least one non-transitory memory storing instructions, which, when executed by the at least one hardware processor, cause the system to:
simulate a plurality of mock users of a first commit of an application included in a first stack;
initiate a mocked import queue for the first commit of the application that simulates simultaneous performance of a plurality of actions associated with the application;
simulate normal network traffic performed by the plurality of mock users occurring simultaneously to the plurality of actions simulated using the mocked import queue; and
measure a performance metric of the application,
wherein the performance metric is associated with performance of the application during simulation of the normal network traffic performed by the plurality of mock users occurring simultaneously to the plurality of actions.

6. The system of claim 5, further comprising instructions to:
associate the measured performance metric with the first commit of the application;
determine that the measured performance metric meets or exceeds a predetermined performance threshold indicating satisfactory performance during periods of high load; and
in response to said determination, automatically generate an indication to replace a second commit of the application with the first commit,
wherein the second commit is accessible to public users and included in a second stack.

7. The system of claim 6, further comprising instructions to:
upload a new commit of the application to the first stack as the first commit via a main branch,
wherein the main branch stores the new commit of the application; and
automatically upload, via the main branch, the new commit of the application to the second stack in response to the indication to replace the second commit of the application with the first commit,
thereby allowing the second commit of the application to be automatically updated to match the new commit after the new commit is determined to meet or exceed the predetermined performance threshold.

8. The system of claim 6, wherein:
the performance metric is one of a response time of the application to a data query call, a rate at which the application processes queued requests from users, a memory usage measurement, a central processing unit (CPU) usage measurement, a network bandwidth consumption measurement, a cache performance measurement, a database performance measurement, or an autoscaling performance measurement.

9. The system of claim 5, wherein:
the mocked import queue performs analogous logic to a corresponding production import queue for a second commit of the application, excluding an application programming interface (API) call made during operation of the production import queue.

10. The system of claim 5, wherein:
a second commit of the application is accessible to public users and included in a second stack; and
wherein dummy authentication tokens are used to simulate the plurality of mock users.

11. The system of claim 5, wherein:
the mocked import queue is used to simulate simultaneous importation of a plurality of email files from a test set,
wherein each email file in the plurality of email files is imported one or more times.

12. The system of claim 5, wherein:
the normal network traffic is simulated by generating random GraphQL API calls from users in the plurality of mock users; and
the plurality of actions are simulated actions by the plurality of mock users.

13. A method comprising:
simulating a plurality of mock users of a first commit of an application included in a first stack;
initiating a mocked import queue for the first commit of the application that simulates simultaneous performance of a plurality of actions associated with the application;
simulating normal network traffic performed by the plurality of mock users occurring simultaneously to the plurality of actions simulated using the mocked import queue; and
measuring a performance metric of the application,
wherein the performance metric is associated with performance of the application during simulation of the normal network traffic performed by the plurality of mock users occurring simultaneously to the plurality of actions.

14. The method of claim 13, further comprising:
associating the measured performance metric with the first commit of the application;
determining that the measured performance metric meets or exceeds a predetermined performance threshold indicating satisfactory performance during periods of high load; and
in response to said determination, automatically generating an indication to replace a second commit of the application with the first commit,
wherein the second commit is accessible to public users and included in a second stack.

15. The method of claim 14, further comprising:
uploading a new commit of the application to the first stack as the first commit via a main branch,
wherein the main branch stores the new commit of the application; and
automatically uploading, via the main branch, the new commit of the application to the second stack in response to the indication to replace the second commit of the application with the first commit,
thereby allowing the second commit of the application to be automatically updated to match the new commit after the new commit is determined to meet or exceed the predetermined performance threshold.

16. The method of claim 14, wherein:
the performance metric is one of a response time of the application to a data query call, a rate at which the application processes queued requests from users, a memory usage measurement, a central processing unit (CPU) usage measurement, a network bandwidth consumption measurement, a cache performance measurement, a database performance measurement, or an autoscaling performance measurement.

17. The method of claim 13, wherein:
the mocked import queue performs analogous logic to a corresponding production import queue for a second commit of the application, excluding an application programming interface (API) call made during operation of the production import queue.

18. The method of claim 13, wherein:
a second commit of the application is accessible to public users and included in a second stack; and
wherein dummy authentication tokens are used to simulate the plurality of mock users.

19. The method of claim 13, wherein:
the mocked import queue is used to simulate simultaneous importation of a plurality of email files from a test set,
wherein each email file in the plurality of email files is imported one or more times.

20. The method of claim 13, wherein:
the normal network traffic is simulated by generating random GraphQL API calls from users in the plurality of mock users; and
the plurality of actions are simulated actions by the plurality of mock users.
